(19) United States
(12) Patent Application Publication
(10) Pub. No.: US 2024/0412076 A1
(43) Pub. Date: Dec. 12, 2024

(54) PRE-PROCESSING FOR DEEP NEURAL NETWORK COMPILATION USING GRAPH NEURAL NETWORKS

(71) Applicant: QUALCOMM Incorporated, San Diego, CA (US)

(72) Inventors: Anuj GUPTA, Bangalore (IN); Himanshu UPRETI, Ghaziabad (IN); Venkata Subba Dheeraj GATTUPALLI, Nellore (IN); Vinayak Narayan BADDI, Bengaluru (IN); Prasanna Ashish BISWAS, Ulhasnagar (IN); Mohit SHARMA, Udaipur (IN)

(21) Appl. No.: 18/330,253

(22) Filed: Jun. 6, 2023

(51) Int. Cl. G06N 3/0985

(52) U.S. Cl. CPC G06N 3/0985

(57) ABSTRACT

A processor-implemented method of pre-processing for deep neural network compilation comprising receiving a representation of an artificial neural network (ANN) model. An operator embedding is generated to represent operators of the ANN model in an embedding space. A graph neural network (GNN) processes the operator embedding to generate a graph embedding corresponding to the ANN model according to a learned distance metric. The GNN determines a set of hyperparameters for the ANN model based on the graph embedding.

### FIELD OF THE DISCLOSURE

Aspects of the present disclosure generally relate to pre-processing for deep neural network (DNN) compilation using graph neural networks.

### BACKGROUND

Artificial neural networks may comprise interconnected groups of artificial neurons (e.g., neuron models). The artificial neural network may be a computational device or be represented as a method to be performed by a computational device. Artificial neural networks, including feed forward neural networks, convolutional neural networks (CNNs), transformers, graph neural networks (GNNs), recurrent neural networks (RNNs), etc., have numerous applications. In particular, these neural network architectures are used in various technologies, such as image recognition, speech recognition, acoustic scene classification, keyword spotting, autonomous driving, and other classification tasks.

Given the many useful applications of neural networks, there is increasing demand for use thereof on edge devices such as smartphones, and in cloud computing. However, edge devices have limited computational resources and generalized models may utilize more complex networks and more computation. Also, for cloud deployments, large models such as large language models may exceed the capacity of the target devices. As such, the memory footprint and high latency for neural networks make their use challenging, particularly for efficient deployment and inference on resource-limited devices.

### SUMMARY

The present disclosure is set forth in the independent claims, respectively. Some aspects of the disclosure are described in the dependent claims.

In one aspect of the present disclosure, a processor-implemented method of pre-processing for deep neural network compilation includes receiving a representation of an artificial neural network (ANN) model. The processor-implemented method still further includes generating an operator embedding to represent operators of the ANN model in an embedding space. The processor-implemented method also includes processing, by a graph neural network (GNN), the operator embedding, to generate a graph embedding corresponding to the ANN model according to a learned distance metric. The processor-implemented method further includes determining, by the GNN, a set of hyperparameters for the ANN model based on the graph embedding.

Another aspect of the present disclosure is directed to an apparatus including means for receiving a representation of an artificial neural network (ANN) model. The apparatus further includes means for generating an operator embedding to represent operators of the ANN model in an embedding space. The apparatus further includes means for processing, by a graph neural network (GNN), the operator embedding, to generate a graph embedding corresponding to the ANN model according to a learned distance metric. The apparatus further includes means for determining, by the GNN, a set of hyperparameters for the ANN model based on the graph embedding.

In another aspect of the present disclosure, a non-transitory computer-readable medium with non-transitory program code recorded thereon is disclosed. The program code is executed by a processor and includes program code to receive a representation of an artificial neural network (ANN) model. The program code still further includes program code to generate an operator embedding to represent operators of the ANN model in an embedding space. The program code also includes program code to process, by a graph neural network (GNN), the operator embedding, to generate a graph embedding corresponding to the ANN model according to a learned distance metric. The program code further includes program code to determine, by the GNN, a set of hyperparameters for the ANN model based on the graph embedding.

Another aspect of the present disclosure is directed to an apparatus having a memory and one or more processors coupled to the memory. The processor(s) is configured to receive a representation of an artificial neural network (ANN) model. The apparatus still further includes means for generate an operator embedding to represent operators of the ANN model in an embedding space. The apparatus also includes means for process, by a graph neural network (GNN), the operator embedding, to generate a graph embedding corresponding to the ANN model according to a learned distance metric. The apparatus further includes means for determine, by the GNN, a set of hyperparameters for the ANN model based on the graph embedding.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a block diagram illustrating an example architecture for pre-processing for deep neural network compilation using a graph neural network in accordance with various aspects of the present disclosure.

FIG. 6 is a block diagram illustrating an example architecture for a metric learning module for training a graph neural network (GNN) using metric learning, in accordance with various aspects of the present disclosure.

FIG. 7 is a block diagram illustrating example an architecture for a relative size preservation module training a GNN using the relative size preservation loss, in accordance with various aspects of the present disclosure.

FIG. 8 is a block diagram illustrating training a GNN using the reconstruction loss, in accordance with various aspects of the present disclosure.

FIG. 9 is a flow diagram illustrating a processor-implemented method for pre-processing for deep neural network compilation using a graph neural network, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Deep neural networks have a large footprint and may suffer extensive latency and power consumption. One approach to reducing the latency in neural networks is via machine learning accelerators. Machine learning accelerators include dedicated processors designed to accelerate machine learning computations, such as multiply accumulate operations in matrix-matrix and matrix-vector operations. To employ machine learning accelerators, machine learning compilers provide a mapping from a trained machine learning model to a given machine learning accelerator. Machine learning compilers aim to optimize the mapping from the machine learning model to the accelerator.

Conventional methods to optimize artificial intelligence (AI) workloads on hardware (HW) accelerators depend on prior knowledge of best configurations for a model architecture or brute force tools. Conventional methods may be unable to scale up to any model or architecture to automatically identify a closest match to a known best configuration and without re-training the AI driven tool. Conventional graph neural network (GNN)-based techniques may generate an embedding for a neural network but are unable to automatically identify models.

Additionally, embeddings of structural and semantic information of the computational graphs may not be transferrable to downstream tasks without retraining. Many of the conventional approaches may generate embeddings only for a particular task.

Accordingly, aspects of the present disclosure are directed to generating embeddings that capture semantic (operator) and structural information of deep neural networks. Each of the generated embeddings may be unique and may beneficially enable backbone and architecture classification and understanding, as well as similarity searches for computational graphs. Additional use cases include recommendations on neural network architecture changes and/or adaptation and optimal performance parameters.

In accordance with aspects of the present disclosure, a graph machine learning approach may be coupled with metric learning to produce model embeddings. The model embeddings may be unique for each model. Models with similar network architecture may be clustered closer to each other in the embedding space, while dissimilar graphs (models) may be farther apart. The embeddings may preserve the semantic operator traits while transforming the graph into the embedding space. In some aspects, the distance between embeddings of the model having a similar sub-structure belonging to the same network architecture may be proportional to their relative size (e.g., number of operators).

The network may be trained using a blended approach based on different objective functions. The proposed approach is an open set solution-thus the same trained model can be used for unseen neural network architectures.

Particular aspects of the subject matter described in this disclosure can be implemented to realize one or more of the following potential advantages. In some examples, the described techniques may enable backbone and architecture classification, as well as recommendations for architecture changes and selection of neural network parameters for increased accuracy and reduced latency.

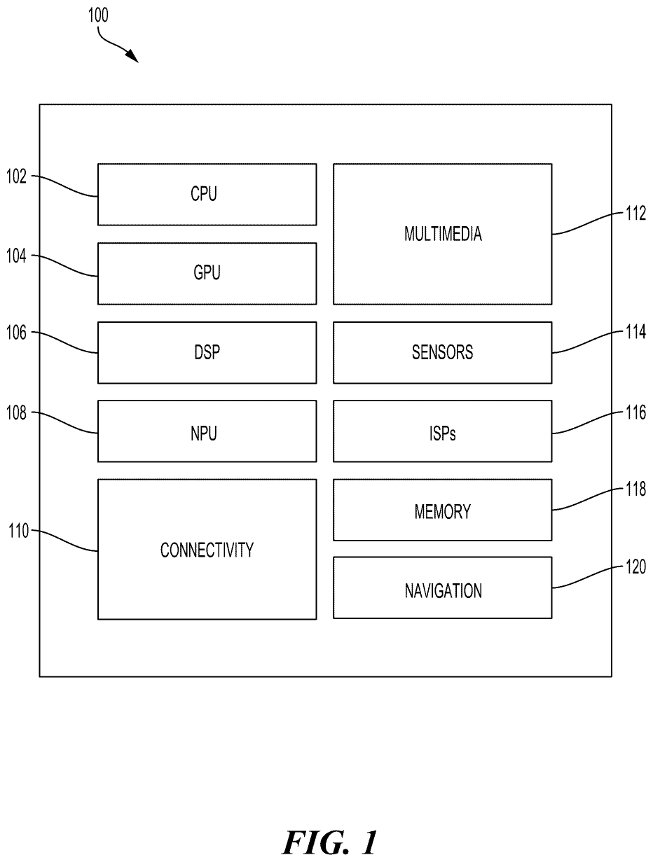

FIG. 1 illustrates an example implementation of a system-on-a-chip (SOC) 100, which may include a central processing unit (CPU) 102 or a multi-core CPU configured for performing preprocessing for deep neural network compilation. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive a representation of an artificial neural network (ANN) model. The general-purpose processor 102 may also include code to generate an operator embedding to represent operators of the ANN model in an embedding space. The general-purpose processor 102 may additionally include code to process, by a graph neural network (GNN), the operator embedding, to generate a graph embedding corresponding to the ANN model according to a learned distance metric. The general-purpose processor 102 may further include code to determine, by the GNN, a set of hyperparameters for the ANN model based on the graph embedding.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

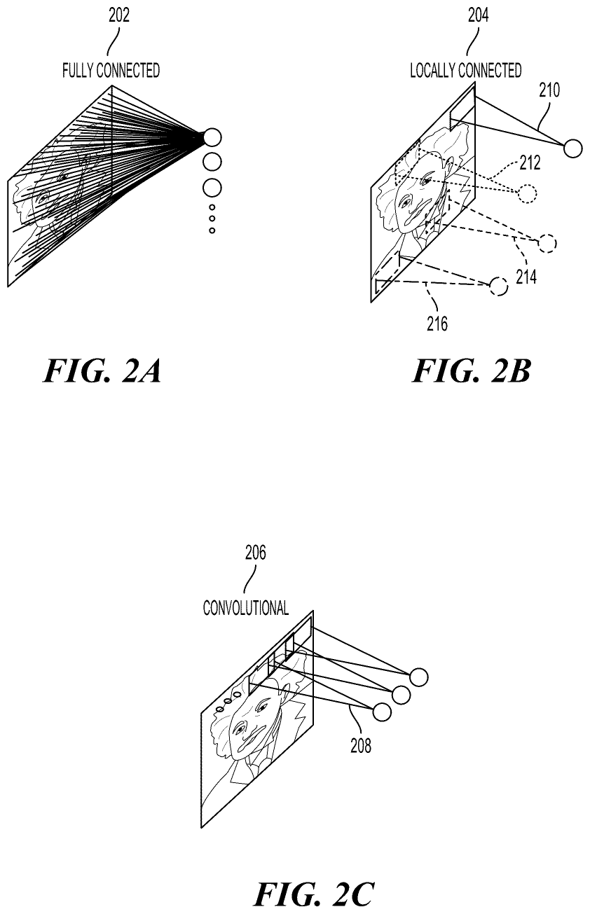

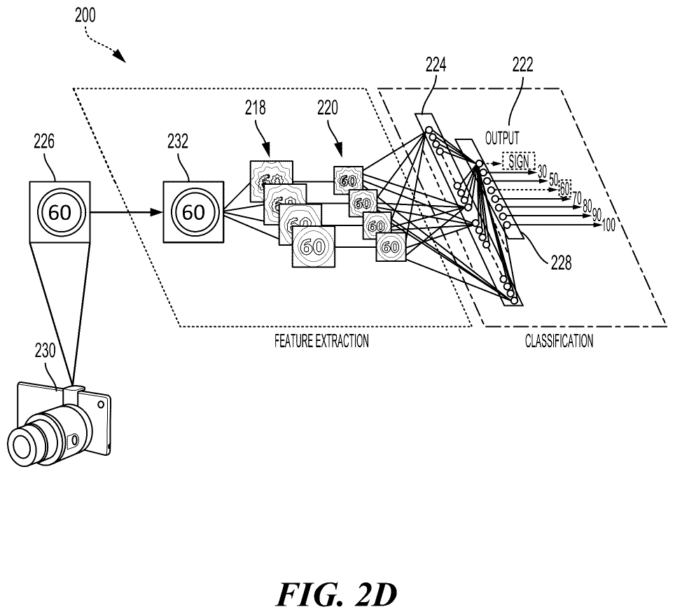

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

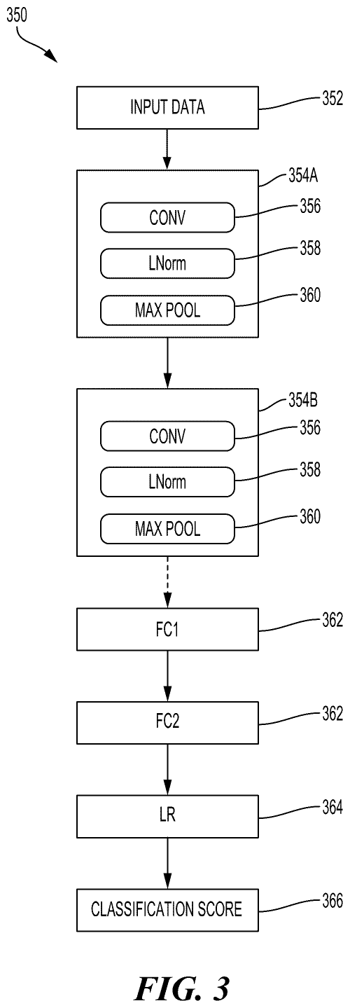

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

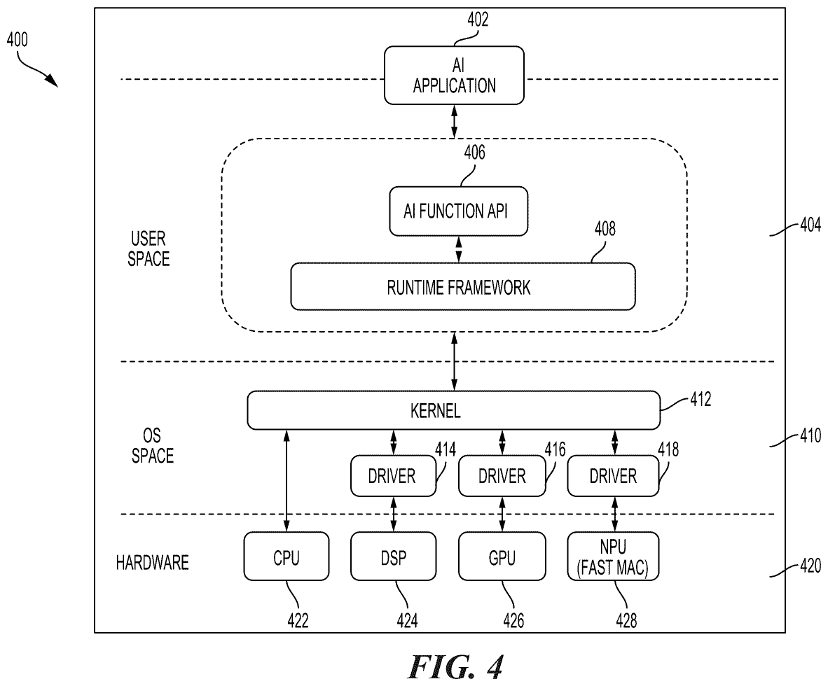

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) to support pre-processing for deep neural network compilation for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The AI application 402 may be configured to call functions defined in the user space 404 that may, for example, provide for the detection and recognition of a scene indicative of the location in which the computational device including the architecture 400 currently operates. The application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine 408, for example, to request a scene estimate at a particular time interval or triggered by an event detected by the user interface of the application. When caused to estimate the scene, the run-time engine 408 may in turn send a signal to the operating system 410, such as the Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as the driver 414-418 for the DSP 424, for the GPU 426, or for the NPU 428. In the exemplary example, the differential neural network may be configured to run on a combination of processing blocks, such as the CPU 422 and the GPU 426, or may be run on the NPU 428.

Aspects of the present disclosure are directed to pre-processing for deep neural network compilation using a graph neural network. Aspects of the present disclosure relate to a pre-trained embedding of a neural network using a graph neural network (GNN). The GNN may be trained according to a metric learning approach.

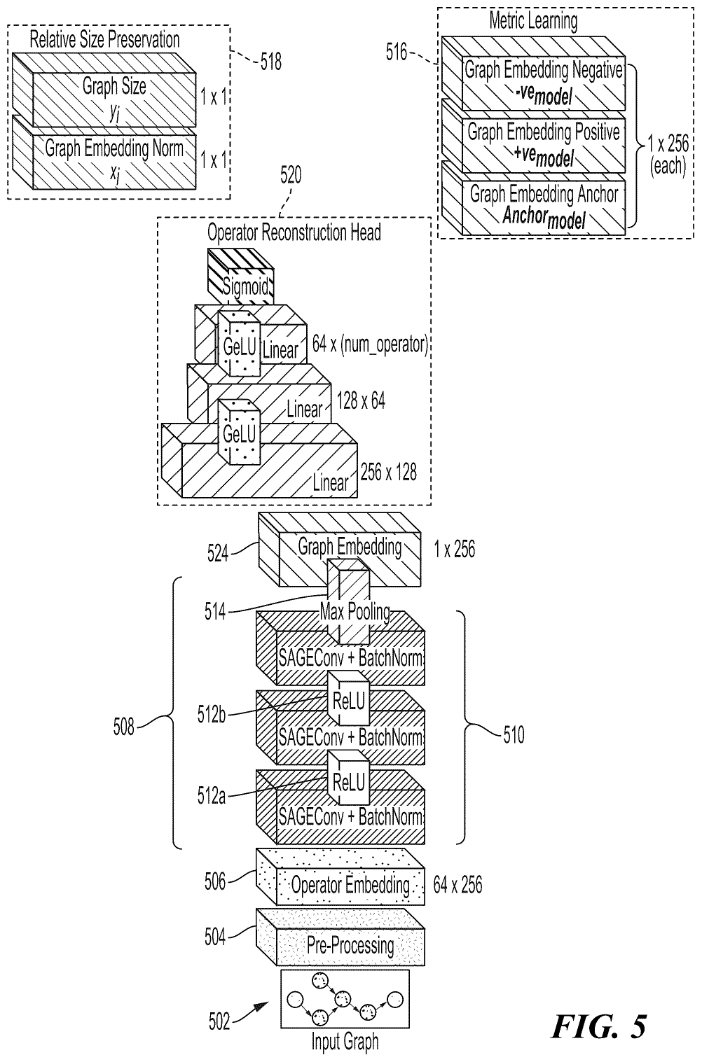

FIG. 5 is a block diagram illustrating an example architecture 500 for pre-processing for deep neural network compilation using a graph neural network in accordance with various aspects of the present disclosure. The example architecture 500 may include a pre-processing module 504, an operator embedding module 506 and a GNN 508. The graph neural network may, for example, be a graph convolutional neural network (GCN), a graph auto-encoder network, a recurrent GNN, or other type of graph neural network model. The GNN 508 may include a set of convolutional layers 510, activation layers 512a, 512b and a max pooling layer 514. The activation layers (e.g., 512a, 512b) may comprise a rectifier linear unit (ReLU), a Gaussian error linear unit (GeLU), or a sigmoid function layer, for instance.

In addition, the example architecture 500 may include a metric learning module 516, a relative size preservation module 518, and an operator reconstruction module 520. The example architecture 500 may receive an artificial neural network (ANN) model 502 as an input. The ANN model 502 may comprise a residual neural network, a transformer neural network, a recurrent convolutional neural network (RCNN), an autoencoder, or other type of artificial neural network. The ANN model 502 may be in the form of a compute graph, a matrix, or other form, for example. The example architecture 500 may be configured to receive the ANN model(s) 502 that vary in size (e.g., number of operators).

The ANN model 502 may be received at the pre-processing module 504. The pre-processing module 504 extracts a set of operators from the ANN model 502. In some aspects, the pre-processing module 504 may generate an adjacency matrix corresponding to the ANN model 502. The extracted operators are supplied to the operator embedding module 506. The operator embedding module 506 extracts features of the operators and generates a representation of the operators of the ANN model 502 in a higher dimensional space. The operator embeddings may be supplied to the GNN 508.

The GNN 508 may process the operator embeddings to capture dependencies of the graph using message passing between operators (e.g., nodes) of the graph. That is, the GNN 508 may determine the relationship between the operators and topology of the ANN model 502 by message passing. For instance, the operator embeddings may be processed by the convolutional layers 510 to extract features of the operator embedding. The extracted features may be aggregated and processed using the activation layers 512a, 512b and the max pooling layer 514 to determine one or more edges or connections between operators as well as parameters (e.g., weights) associated with the one or more edges. Accordingly, the GNN 508 may generate a graph embedding 524 corresponding to the ANN model 502. The GNN 508 may generate the graph embedding 524 corresponding to each ANN model 502 such that the graph embedding 524 may be unique (different than graph embeddings for other ANN models). In addition, the GNN 508 may generate graph embeddings (e.g., 524) that preserve the semantic operator traits while transforming the compute graph for the ANN model 502 into the embedding space. Each of the generated graph embeddings may be stored in a database of graph embeddings along with a set of training samples. The database may be maintained in memory such as memory 118 of FIG. 1 for example or another data storage device.

The GNN 508 may be trained to generate the graph embedding using the metric learning module 516. The metric learning module 516 implements a metric learning technique. Metric learning is a task of learning a distance function over objects. In accordance with aspects of the present disclosure, the GNN 508 may be trained to cluster positive samples close to an anchor. That is, similar samples (e.g., ANNs) may be clustered together in the embedding space, while dissimilar samples may be spaced farther apart in the embedding space. The metric learning may be conducted according to a triplet loss which is given by:

$$TripletLoss = max ( d ( {Anchor}_{model} , + {ve}_{model} ) - d ( {Anchor}_{model} , - {ve}_{model} ) + margin , 0 ) , \qquad ( 1 )$$

where d is a distance function, the Anchor_{model} is a sample (e.g., ANN model) selected from a training data set, +ve_{model} represents an ANN model that is similar to (or the same as) the Anchor_{model}, −ve_{model} represents an ANN model that is different than the Anchor_{model}, and margin represents the distance between two classes of ANN model which belong to different categories of +ve_{model} or −V_{emodel} samples.

In some aspects, the GNN 508 may also be trained using the relative size preservation module 518. The relative size preservation module 518 may be used to train the GNN 508 such that the distance between graph embeddings may be proportional to the relative size of the ANN models according to a RelativeSizePreservationLoss objective which is given by:

$$RelativeSizePreservationLoss = {\sum }_{\{ i = 1 \}}^{d} {( {x}_{i} - {y}_{i} )}^{2} , \qquad ( 2 )$$

where xᵢ represents an estimated count of operators in the ANN model (e.g., 502) and yᵢ represents an actual count of operators in the ANN model (e.g., 502).

By training the GNN 508 based on the RelativeSizePreservationLoss, the GNN 508 may maintain a size (e.g., number of operators) ratio between similar architectures. For instance, where the ANN model 502 has an unseen architecture (no match in the training data set), the GNN 508 may determine that such ANN model 502 has a similar substructure as a sample ANN. The GNN 508 trained according to the RelativeSizePreservationLoss may identify the ratio of such architectures with each other (e.g., the ANN model 502 relative to the identified sample ANN). Accordingly, the GNN 508 may generate a graph embedding 524 for the unseen ANN model 502 which maintains the identified size ratio.

In some aspects, the GNN 508 may also be trained based on reconstruction loss using the operator reconstruction module 520. The operator reconstruction module 520 may take as input, the graph embedding 524 output by the GNN 508. The operator reconstruction module 520 processes the graph embedding 524 to determine an accuracy (e.g., degree of correspondence) of the graph embedding (e.g., 524) to the ANN model 502. The accuracy of the graph embedding may be determined according to the operator reconstruction loss, which may be expressed as:

$$OperatorReconstructionLoss = - \frac{{O}_{i}}{log ( {p}_{i} )} + \frac{( 1 - {O}_{i} )}{log ( 1 - {p}_{i} )} \qquad ( 3 )$$

where Oᵢ represents the label of an operator and pi represents the probability of the operator.

In some aspects, the metric learning module 516 may be operated concurrently with the relative size preservation module 518 and/or the operator reconstruction module 520 during training of the GNN 508. For instance, each of the metric learning module 516, the relative size preservation module 518 and the operator reconstruction module 520 may concurrently receive the graph embedding and compute the respective loss as shown in Equations 1-3. Then the respective losses may be aggregated to produce a total loss.

Following training of the GNN 508, the metric learning module 516, the relative size preservation module 518 and the operator reconstruction module 520 may be removed and architecture 500 may be operated without such modules during inference.

Accordingly, aspects of the present disclosure may beneficially employ an open-set approach. That is, the example architecture may be scaled to generate embeddings for unseen neural networks, thus avoiding retraining.

Additionally, aspects of the present disclosure may train downstream tasks that use computational graphs as an input with limited data. For instance, the graph embeddings may be used to identify the architecture of an input ANN or the backbone of the input ANN, to determine a fusion of operators in the ANN model and other downstream tasks.

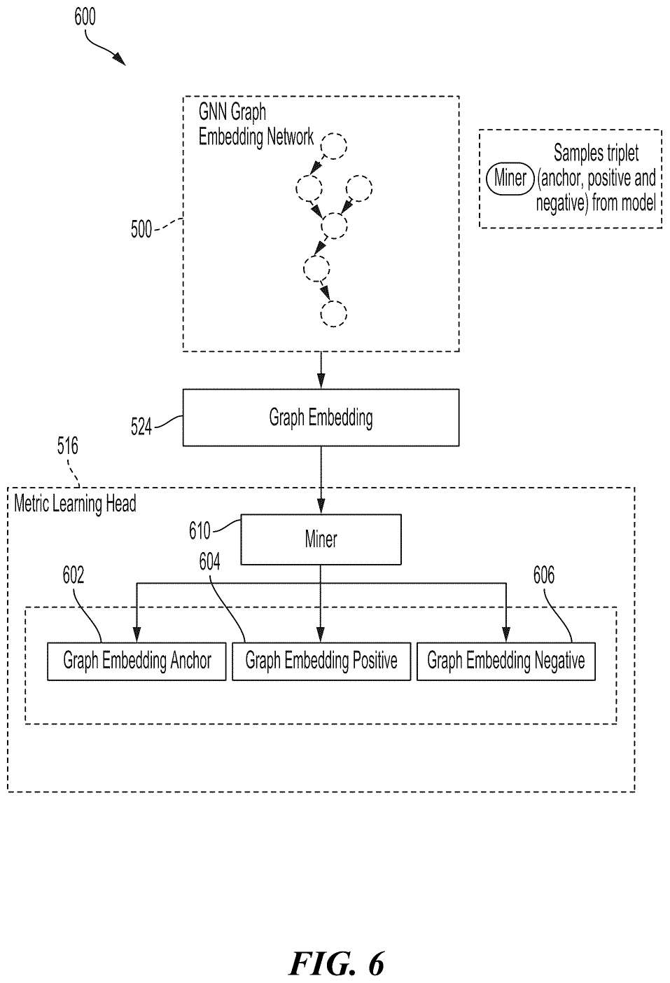

FIG. 6 is a block diagram illustrating an example architecture 600 for the metric learning module 516 for training the GNN (e.g., 508) using metric learning, in accordance with various aspects of the present disclosure. As shown in FIG. 6, the metric learning module 516 may be configured as a Siamese-type network for comparing a set of inputs.

The graph embeddings 524 from the example architecture 500 may be learned in a way where the generated embeddings 524 may be projected to a high dimensional embedding space, such that similar ANNs may be clustered and projected closer together. On the other hand, dissimilar ANNs may be projected farther away from each other.

During training, a graph embedding anchor 602 may be selected as a reference input by a miner 610. For instance, the anchor 602 may be selected by a random sampling or other sampling technique. A graph embedding positive 604 (e.g., same identity as the anchor) and a graph embedding negative 606 (e.g., different identity than the anchor) may be received as inputs by the metric learning module 516. The TripletLoss shown in Equation 1 may be used to minimize the distance between the graph embedding anchor 602 and the graph embedding positive 604 while maximizing the distance between the graph embedding anchor 602 and the graph embedding negative 606.

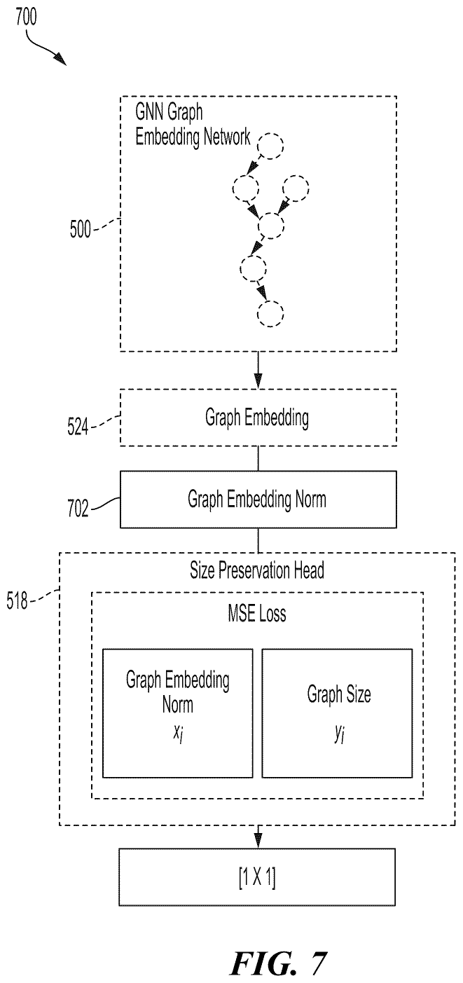

FIG. 7 is a block diagram illustrating an example architecture 700 for the relative size preservation module 518 training the GNN (e.g., 508) using relative size preservation loss, in accordance with various aspects of the present disclosure. Referring to FIG. 7, the relative size preservation module 518 may receive a graph embedding 524 and a graph embedding norm 702. The relative size preservation module 518 may compare the graph embedding 524 to a graph embedding having similar sub-structure. The relative size preservation module 518 may determine the RelativeSizePreservationLoss (as shown in Equation 2) based on the graph embedding 524 and the graph embedding having similar sub-structure. The GNN (e.g., 508) may adapt each of the graph embeddings based on the RelativeSizePreservationLoss such that the norm of the graph embeddings (e.g., 702) is proportional to the relative size of each, based on a number of operators, for instance.

Accordingly, by using the relative size preservation module 518 for training, the GNN (e.g., 508) may generate a graph embedding for ANNs with similar substructure (e.g., residual networks such as Resnet18, Resnet34, and Resnet101) such that the respective graph embeddings have separate values and the distance among the respective graph embeddings may be linear.

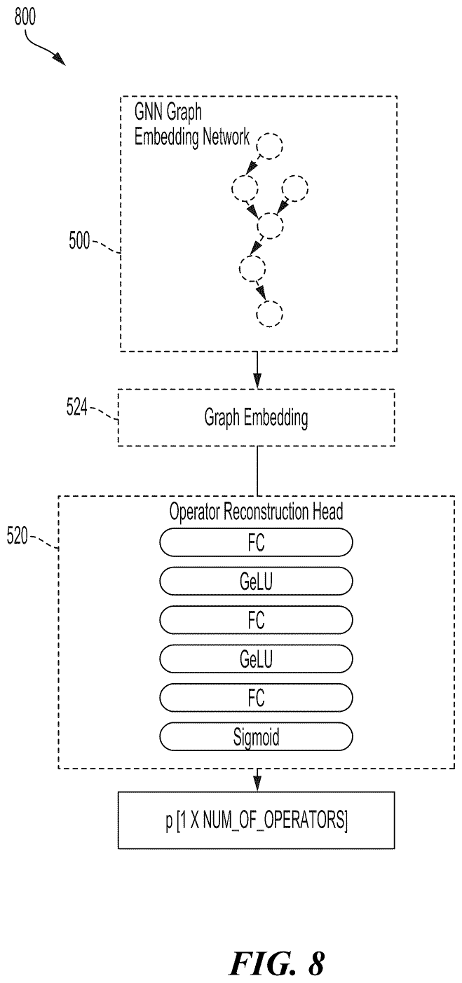

FIG. 8 is a block diagram illustrating training a GNN (e.g., 508) using the reconstruction loss, in accordance with various aspects of the present disclosure. Referring to FIG. 8, the operator reconstruction module 520 may receive a graph embedding 524 from the example architecture 500.

In some aspects, while generating the graph embedding 802, the GNN (e.g., 508) may lose some operator information. To reduce the occurrence of operator information loss, the operator reconstruction module 520 may be trained concurrently with the GNN (e.g., 508) to retain the operator information in the graph embedding.

The operator reconstruction module 520 may include a classification network, which uses a sigmoid activation function to estimate the operators present in the ANN model (e.g., 502) based on the graph embedding 524. The operator reconstruction module 520 may compare the estimated operators with the actual operators of the ANN model (e.g., 502) to compute the OperatorReconstructionLoss, as shown in Equation 3. Using the OperatorReconstructionLoss, the GNN (e.g., 508) may adapt the graph embeddings 524 to preserve operator information such as information of unique and less frequent operators.

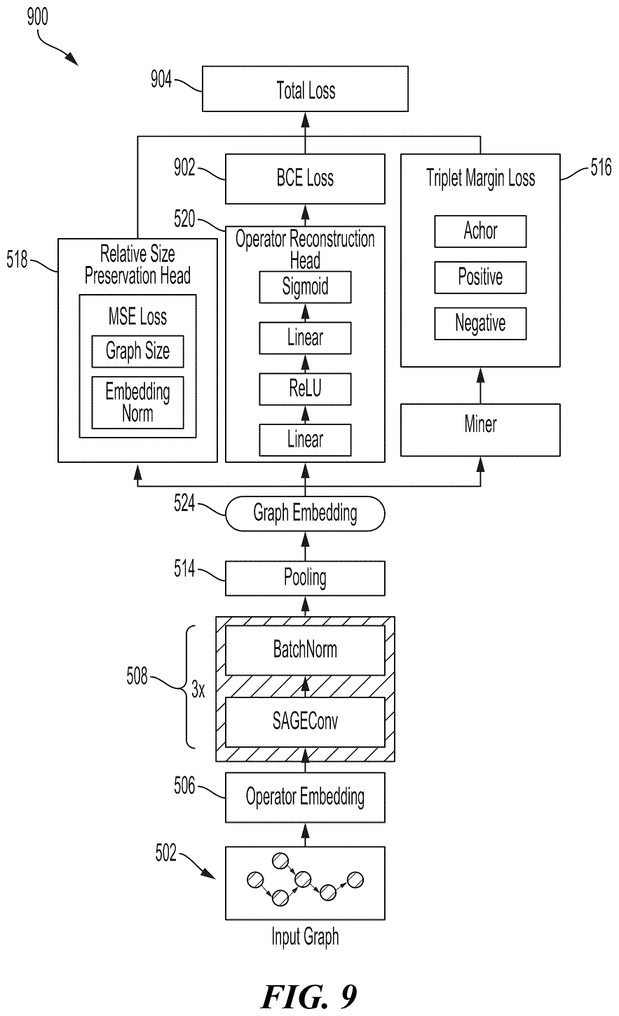

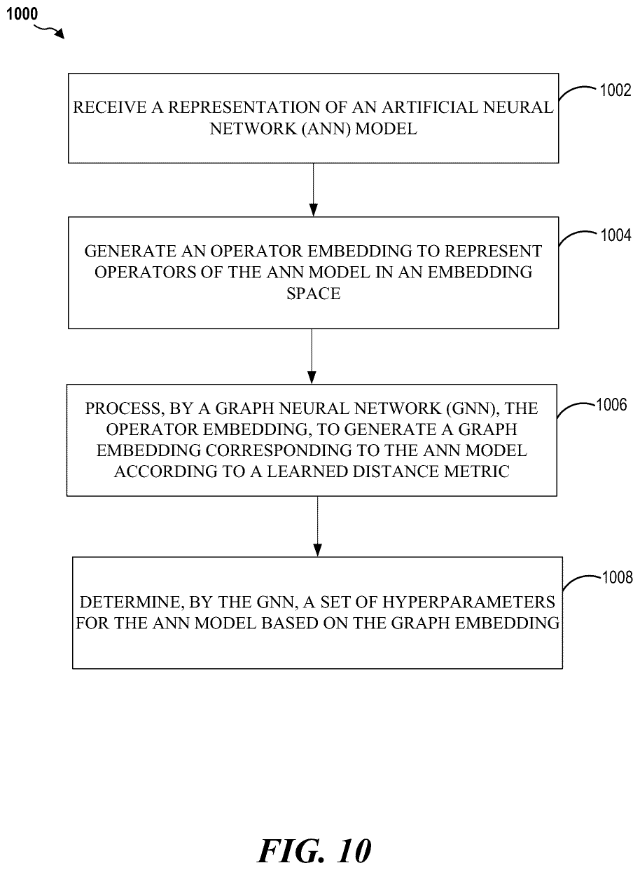

FIG. 9 is a block diagram illustrating an example architecture 900 for training the GNN (e.g., 508), in accordance with various aspects of the present disclosure. Referring to FIG. 9, an input graph (e.g., 502) of a training data set (e.g., for a known ANN) may be received. The input graph (e.g., 502) may be preprocess and to generate operator embeddings which may be supplied to the GNN 508. The GNN 508 may process the operator embeddings to generate a graph embedding 524.

The graph embedding 524 may be supplied to one or more of the metric learning module 516, the relative size preservation module 518 and the operator reconstruction module 520, which may be used to train the GNN 508. In the example of FIG. 9, the OperatorReconstructionLoss computed by the operator reconstruction module 520 may be used to compute a binary cross entropy (BCE) loss 902. The BCE loss 902 may combined with the TripletLoss computed by the metric learning module 516 and the RelativeSizePreservationLoss computed by the relative size preservation module 518 to produce to total loss 904. The total loss 904 may be used to train the GNN 508 (e.g., backpropagation) to generate the graph embedding.

FIG. 10 is a flow diagram illustrating a processor-implemented method 1000 for pre-processing for deep neural network compilation using a graph neural network, in accordance with various aspects of the present disclosure. The processor implemented method 1000 may be performed by a processor such as CPU 102, for example.

As shown in FIG. 10, at block 1002, the processor receives a representation of an artificial neural network (ANN) model. For example, as described with reference to FIG. 5, The example architecture 500 may receive an artificial neural network (ANN) model 502 as an input. The ANN model 502 may comprise a residual neural network, a transformer neural network, a recurrent convolutional neural network (RCNN), an autoencoder, or other type of artificial neural network. The ANN model 502 may be in the form of a compute graph, a matrix, or other form, for example.

At block 1004, the processor generates an operator embedding to represent operators of the ANN model in an embedding space. As described with referenced to FIG. 5, the ANN model 502 may be received at the pre-processing module 504. The pre-processing module 504 extracts a set of operators from the ANN model 502. In some aspects, the pre-processing module 504 may generate an adjacency matrix corresponding to the ANN model 502. The extracted operators are supplied to the operator embedding module 506. The operator embedding module 506 extracts features of the operators and generates a representation of the operators of the ANN model 502 in a higher dimensional space.

At block 1006, the processor processes, by a graph neural network (GNN), the operator embedding, to generate a graph embedding corresponding to the ANN model according to a learned distance metric. For instance, as described with reference to FIG. 5, the GNN 508 may process the operator embeddings to capture dependencies of the graph using message passing between operators (e.g., nodes) of the graph. That is, the GNN 508 may determine the relationship between the operators and topology of the ANN model 502 by message passing. For instance, the operator embeddings may be processed by the convolutional layers 510 to extract features of the operator embedding. The extracted features may be aggregated and processed using the activation layers 512a, 512b and the max pooling layer 514 to determine one or more edges or connections between operators as well as parameters (e.g., weights) associated with the one or more edges. Accordingly, the GNN 508 may generate a graph embedding 524 corresponding to the ANN model 502.

Additionally, the GNN 508 may be trained to generate the graph embedding using the metric learning module 516. The metric learning module 516 implements a metric learning technique. Metric learning is a task of learning a distance function over objects. In accordance with aspects of the present disclosure, the GNN 508 may be trained to cluster positive samples close to an anchor. That is, similar samples (e.g., ANNs) may be clustered together in the embedding space, while dissimilar samples may be spaced farther apart in the embedding space.

At block 1008, the processor determines, by the GNN, a set of hyperparameters for the ANN model based on the graph embedding. In some aspects, the set of hyperparameters for the ANN model may be determined using a similarity search over a set of graph embeddings corresponding to ANN models previously tuned for a hardware accelerator.

Implementation examples are provided in the following numbered clauses.

1. A processor-implemented method of pre-processing for deep neural network compilation, comprising:
receiving a representation of an artificial neural network (ANN) model;
generating an operator embedding to represent operators of the ANN model in an embedding space;
processing, by a graph neural network (GNN), the operator embedding, to generate a graph embedding corresponding to the ANN model according to a learned distance metric; and
determining, by the GNN, a set of hyperparameters for the ANN model based on the graph embedding.
   2. The processor-implemented method of clause 1, in which the GNN determines the graph embedding based on a metric learning objective.
   3. The processor-implemented method of clause 1 or 2, in which a distance between the graph embedding corresponding to the ANN model and a second graph embedding corresponding to a second ANN model is proportional to a relative size of the ANN model and the second ANN model.
   4. The processor-implemented method of any of clauses 1-3, in which the GNN is trained based on a reconstruction loss.
   5. The processor-implemented method of any of clauses 1-4, in which the graph embedding corresponding to the ANN model is unique.
   6. The processor-implemented method of any of clauses 1-5, further comprising compiling the ANN model using the set of hyperparameters.
   7. The processor-implemented method of any of clauses 1-6, further comprising determining, by the GNN, the set of hyperparameters for the ANN model using a similarity search over a set of graph embeddings corresponding to ANN models.
   8. An apparatus, comprising:
a memory; and
at least one processor coupled to the memory, the at least one processor configured:
to receive a representation of an artificial neural network (ANN) model;
to generate an operator embedding to represent operators of the ANN model in an embedding space;
to process, by a graph neural network (GNN), the operator embedding, to generate a graph embedding corresponding to the ANN model according to a learned distance metric; and
to determine, by the GNN, a set of hyperparameters for the ANN model based on the graph embedding.
   9. The apparatus of clause 8, in which the GNN determines the graph embedding based on a metric learning objective.
   10. The apparatus of clause 8 or 9, in which a distance between the graph embedding corresponding to the ANN model and a second graph embedding corresponding to a second ANN model is proportional to a relative size of the ANN model and the second ANN model.
   11. The apparatus of any of clauses 8-10, in which the GNN is trained based on a reconstruction loss.
   12. The apparatus of any of clauses 8-11, in which the graph embedding corresponding to the ANN model is unique.
   13. The apparatus of any of clauses 8-12, in which the at least one processor is further configured to compile the ANN model using the set of hyperparameters.
   14. The apparatus of any of clauses 8-13, in which the at least one processor is further configured to determine, by the GNN, the set of hyperparameters for the ANN model using a similarity search over a set of graph embeddings corresponding to ANN models.
   15. A non-transitory computer-readable medium having program code recorded thereon, the program code executed by a processor and comprising:
program code to receive a representation of an artificial neural network (ANN) model;
program code to generate an operator embedding to represent operators of the ANN model in an embedding space;
program code to process, by a graph neural network (GNN), the operator embedding, to generate a graph embedding corresponding to the ANN model according to a learned distance metric; and
program code to determine, by the GNN, a set of hyperparameters for the ANN model based on the graph embedding.
   16. The non-transitory computer-readable medium of clause 15, in which the GNN determines the graph embedding based on a metric learning objective.
   17. The non-transitory computer-readable medium of clause 15 or 16, in which a distance between the graph embedding corresponding to the ANN model and a second graph embedding corresponding to a second ANN model is proportional to a relative size of the ANN model and the second ANN model.
   18. The non-transitory computer-readable medium of any of clauses 15-17, in which the GNN is trained based on a reconstruction loss.
   19. The non-transitory computer-readable medium of any of clauses 15-18, in which the graph embedding corresponding to the ANN model is unique.
   20. The non-transitory computer-readable medium of any of clauses 15-19, in which the program code comprises program code to compile the ANN model using the set of hyperparameters.
   21. The non-transitory computer-readable medium of any of clauses 15-20, in which the program code comprises program code to determine, by the GNN, the set of hyperparameters for the ANN model using a similarity search over a set of graph embeddings corresponding to ANN models.
   22. An apparatus, comprising:
means for receiving a representation of an artificial neural network (ANN) model;
means for generating an operator embedding to represent operators of the ANN model in an embedding space;
means for processing, by a graph neural network (GNN), the operator embedding, to generate a graph embedding corresponding to the ANN model according to a learned distance metric; and
   means for determining, by the GNN, a set of hyperparameters for the ANN model based on the graph embedding.
   23. The apparatus of clause 22, in which the GNN determines the graph embedding based on a metric learning objective.
   24. The apparatus of clause 22 or 23, in which a distance between the graph embedding corresponding to the ANN model and a second graph embedding corresponding to a second ANN model is proportional to a relative size of the ANN model and the second ANN model.
   25. The apparatus of any of clauses 22-24, in which the GNN is trained based on a reconstruction loss.
   26. The apparatus of any of clauses 22-25, in which the graph embedding corresponding to the ANN model is unique.
   27. The apparatus of any of clauses 22-26, further comprising means for compiling the ANN model using the set of hyperparameters.
   28. The apparatus of any of clauses 22-27, further comprising means for determining, by the GNN, the set of hyperparameters for the ANN model using a similarity search over a set of graph embeddings corresponding to ANN models.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method of pre-processing for deep neural network compilation, comprising:
receiving a representation of an artificial neural network (ANN) model;
generating an operator embedding to represent operators of the ANN model in an embedding space;
processing, by a graph neural network (GNN), the operator embedding, to generate a graph embedding corresponding to the ANN model according to a learned distance metric; and
determining, by the GNN, a set of hyperparameters for the ANN model based on the graph embedding.

2. The processor-implemented method of claim 1, in which the GNN determines the graph embedding based on a metric learning objective.

3. The processor-implemented method of claim 1, in which a distance between the graph embedding corresponding to the ANN model and a second graph embedding corresponding to a second ANN model is proportional to a relative size of the ANN model and the second ANN model.

4. The processor-implemented method of claim 1, in which the GNN is trained based on a reconstruction loss.

5. The processor-implemented method of claim 1, in which the graph embedding corresponding to the ANN model is unique.

6. The processor-implemented method of claim 1, further comprising compiling the ANN model using the set of hyperparameters.

7. The processor-implemented method of claim 1, further comprising determining, by the GNN, the set of hyperparameters for the ANN model using a similarity search over a set of graph embeddings corresponding to ANN models.

8. An apparatus, comprising:
a memory; and
at least one processor coupled to the memory, the at least one processor configured:
to receive a representation of an artificial neural network (ANN) model;
to generate an operator embedding to represent operators of the ANN model in an embedding space;
to process, by a graph neural network (GNN), the operator embedding, to generate a graph embedding corresponding to the ANN model according to a learned distance metric; and
to determine, by the GNN, a set of hyperparameters for the ANN model based on the graph embedding.

9. The apparatus of claim 8, in which the GNN determines the graph embedding based on a metric learning objective.

10. The apparatus of claim 8, in which a distance between the graph embedding corresponding to the ANN model and a second graph embedding corresponding to a second ANN model is proportional to a relative size of the ANN model and the second ANN model.

11. The apparatus of claim 8, in which the GNN is trained based on a reconstruction loss.

12. The apparatus of claim 8, in which the graph embedding corresponding to the ANN model is unique.

13. The apparatus of claim 8, in which the at least one processor is further configured to compile the ANN model using the set of hyperparameters.

14. The apparatus of claim 8, in which the at least one processor is further configured to determine, by the GNN, the set of hyperparameters for the ANN model using a similarity search over a set of graph embeddings corresponding to ANN models.

15. A non-transitory computer-readable medium having program code recorded thereon, the program code executed by a processor and comprising:
program code to receive a representation of an artificial neural network (ANN) model;
program code to generate an operator embedding to represent operators of the ANN model in an embedding space;
program code to process, by a graph neural network (GNN), the operator embedding, to generate a graph embedding corresponding to the ANN model according to a learned distance metric; and
program code to determine, by the GNN, a set of hyperparameters for the ANN model based on the graph embedding.

16. The non-transitory computer-readable medium of claim 15, in which the GNN determines the graph embedding based on a metric learning objective.

17. The non-transitory computer-readable medium of claim 15, in which a distance between the graph embedding corresponding to the ANN model and a second graph embedding corresponding to a second ANN model is proportional to a relative size of the ANN model and the second ANN model.

18. The non-transitory computer-readable medium of claim 15, in which the GNN is trained based on a reconstruction loss.

19. The non-transitory computer-readable medium of claim 15, in which the graph embedding corresponding to the ANN model is unique.

20. The non-transitory computer-readable medium of claim 15, in which the program code comprises program code to compile the ANN model using the set of hyperparameters.

21. The non-transitory computer-readable medium of claim 15, in which the program code comprises program code to determine, by the GNN, the set of hyperparameters for the ANN model using a similarity search over a set of graph embeddings corresponding to ANN models.

22. An apparatus, comprising:
means for receiving a representation of an artificial neural network (ANN) model;
means for generating an operator embedding to represent operators of the ANN model in an embedding space;
means for processing, by a graph neural network (GNN), the operator embedding, to generate a graph embedding corresponding to the ANN model according to a learned distance metric; and
means for determining, by the GNN, a set of hyperparameters for the ANN model based on the graph embedding.

23. The apparatus of claim 22, in which the GNN determines the graph embedding based on a metric learning objective.

24. The apparatus of claim 22, in which a distance between the graph embedding corresponding to the ANN model and a second graph embedding corresponding to a second ANN model is proportional to a relative size of the ANN model and the second ANN model.

25. The apparatus of claim 22, in which the GNN is trained based on a reconstruction loss.

26. The apparatus of claim 22, in which the graph embedding corresponding to the ANN model is unique.

27. The apparatus of claim 22, further comprising means for compiling the ANN model using the set of hyperparameters.

28. The apparatus of claim 22, further comprising means for determining, by the GNN, the set of hyperparameters for the ANN model using a similarity search over a set of graph embeddings corresponding to ANN models.
